(19) United States
(12) Patent Application Publication
(10) Pub. No.: US 2026/0211525 A1
(43) Pub. Date: Jul. 23, 2026

(54) ELECTRONIC DEVICE, TOUCH SENSING CIRCUIT AND TOUCH SENSING METHOD

(71) Applicant: Novatek Microelectronics Corp., Hsinchu (TW)

(72) Inventors: Hung-Kai Chen, Taipei City (TW); Feng-Lin Chan, Hsinchu County (TW); Che-Chia Hsu, Hsinchu City (TW); Shang-Ming Tai, Miaoli County (TW); Yi-Hsien Wang, Hsinchu County (TW)

(73) Assignee: Novatek Microelectronics Corp., Hsinchu (TW)

(21) Appl. No.: 19/287,801

(22) Filed: Jul. 31, 2025

Related U.S. Application Data
(60) Provisional application No. 63/747,374, filed on Jan. 21, 2025.

(51) Int. Cl. G06F 3/041; G06F 3/044

(52) U.S. Cl. CPC G06F 3/04186; G06F 3/0446; G06F 2203/04108

(57) ABSTRACT

An electronic device including a touch panel and a touch sensing circuit is provided. The touch panel includes a plurality of first signal lines and a plurality of second signal lines. The touch panel is configured to perform a touch sensing operation in a touch sensing phase. The touch sensing phase includes a first sensing period and a second sensing period. The touch sensing circuit is configured to drive the touch panel to perform the touch sensing operation in the touch sensing phase. The touch sensing circuit receives a first touch sensing data from the touch panel in the first sensing period and a second touch sensing data from the touch panel in the second sensing period. The touch sensing circuit determines a position of a touch event on the touch panel according to a comparison result of the first touch sensing data and the second touch sensing data.

### CROSS-REFERENCE TO RELATED APPLICATION

This application claims the priority benefit of U.S. Provisional application Ser. No. 63/747,374, filed on Jan. 21, 2025. The entirety of the above-mentioned patent applications is hereby incorporated by reference herein and made a part of this specification.

### BACKGROUND

### Technical Field

The invention relates to an electronic device, a sensing circuit and a sensing method, more specifically, to an electronic device, a touch sensing circuit and a touch sensing method.

### Description of Related Art

A number of factors can affect the operation of a touch system. Water falling onto the touch panel can cause changes in the electric field between the electrodes, resulting in miscontacts or malfunctions. Noise from chargers and interference from high-power devices can enter the touch system through the electrodes, affecting the sensitivity of the touch system and causing misjudgment or unresponsiveness.

In hover touch applications, poor grounding of the human body causes the electric field change of a large area press to be different from the finger grounding. This in turn causes the touch system to fail to recognize the finger or other touches (e.g. water), and affects the accuracy of the touch operation. Therefore, it is essential to consider these external interferences when designing a touch system and take the necessary protective measures to ensure stable operation.

In the related art, to avoid the influence of chargers and other related interferences on the touch system, a filter is designed in touch ICs to allow the operating frequency of the touch system to pass through and block the noise outside the operating frequency.

However, the filter design is often more complicated, and there is still only a certain degree of attenuation in the frequency transition area. The use of a poor charger can still prevent the touch system from working properly.

### SUMMARY

The invention is directed to an electronic device, a touch sensing circuit and a touch sensing method, capable of avoiding misjudgment of sensing target objects.

An embodiment of the invention provides an electronic device, including a touch panel and a touch sensing circuit. The touch panel includes a plurality of first signal lines and a plurality of second signal lines. The touch panel is configured to perform a touch sensing operation in a touch sensing phase. The touch sensing phase includes a first sensing period and a second sensing period. The touch sensing circuit is coupled to the touch panel. The touch sensing circuit is configured to drive the touch panel to perform the touch sensing operation in the touch sensing phase. The touch sensing circuit receives a first touch sensing data from the touch panel in the first sensing period and a second touch sensing data from the touch panel in the second sensing period. The touch sensing circuit determines a position of a touch event on the touch panel according to a comparison result of the first touch sensing data and the second touch sensing data.

An embodiment of the invention provides a touch sensing circuit, including a touch controller. The touch controller is coupled to a touch panel. The touch controller is configured to drive the touch panel to perform a touch sensing operation in a touch sensing phase. The touch sensing phase includes a first sensing period and a second sensing period. The touch controller receives a first touch sensing data from the touch panel in the first sensing period and a second touch sensing data from the touch panel in the second sensing period. The touch controller determines a position of a touch event on the touch panel according to a comparison result of the first touch sensing data and the second touch sensing data.

An embodiment of the invention provides a touch sensing method, including: performing a touch sensing operation in a touch sensing phase, wherein the touch sensing phase includes a first sensing period and a second sensing period; receiving a first touch sensing data from a touch panel in the first sensing period and a second touch sensing data from the touch panel in the second sensing period; comparing the first touch sensing data and the second touch sensing data to obtain a comparison result; and determining a position of a touch event on the touch panel according to the comparison result of the first touch sensing data and the second touch sensing data.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic block diagram illustrating an electronic device according to an embodiment of the invention.

FIG. 2 is a schematic diagram illustrating the touch panel depicted in FIG. 1.

FIG. 3A is a schematic diagram illustrating a first touch sensing data obtained in first sensing period according to an embodiment of the invention.

FIG. 3B is a schematic diagram illustrating a second touch sensing data obtained a second sensing period according to the embodiment of the invention.

FIG. 4A is a schematic diagram illustrating a first touch sensing data obtained in first sensing period according to another embodiment of the invention.

FIG. 4B is a schematic diagram illustrating a second touch sensing data obtained a second sensing period according to another embodiment of the invention.

FIG. 5 is a schematic diagram illustrating a second touch sensing data obtained in second sensing period according to another embodiment of the invention.

FIG. 6A is a schematic diagram illustrating a first touch sensing data obtained in first sensing period according to another embodiment of the invention.

FIG. 6B is a schematic diagram illustrating a second touch sensing data obtained a second sensing period according to another embodiment of the invention.

FIG. 7A is a schematic diagram illustrating a first touch sensing data obtained in first sensing period according to another embodiment of the invention.

FIG. 7B is a schematic diagram illustrating a second touch sensing data obtained a second sensing period according to another embodiment of the invention.

FIG. 8 is a flowchart illustrating steps in a touch sensing method according to an embodiment of the invention.

### DESCRIPTION OF THE EMBODIMENTS

Embodiments are provided below to describe the disclosure in detail, though the disclosure is not limited to the provided embodiments, and the provided embodiments can be suitably combined. The term “coupling/coupled” or “connecting/connected” used in this specification (including claims) of the application may refer to any direct or indirect connection means. For example, “a first device is coupled to a second device” should be interpreted as “the first device is directly connected to the second device” or “the first device is indirectly connected to the second device through other devices or connection means.” The term “signal” can refer to a current, a voltage, a charge, a temperature, data, electromagnetic wave or any one or multiple signals. In addition, the term “and/or” can refer to “at least one of”. For example, “a first signal and/or a second signal” should be interpreted as “at least one of the first signal and the second signal”.

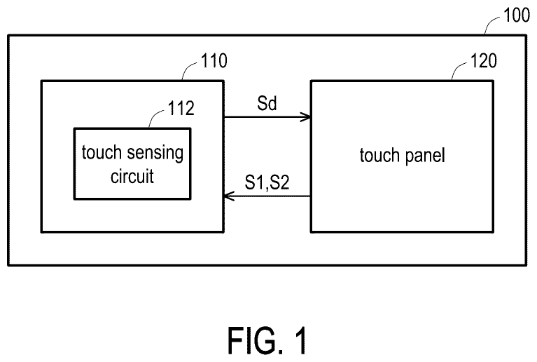

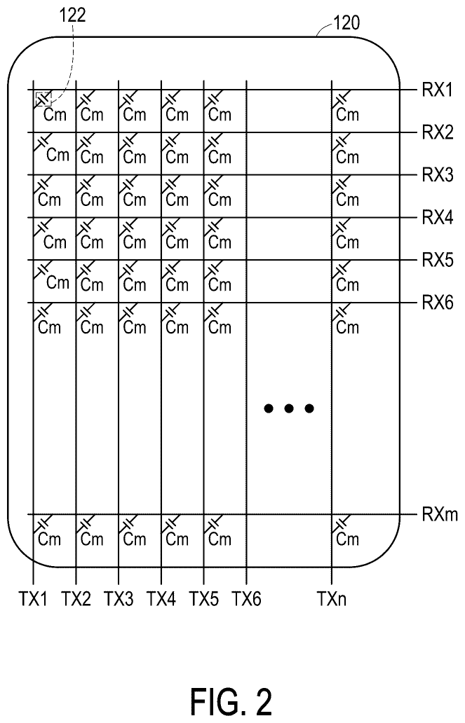

FIG. 1 is a schematic block diagram illustrating an electronic device according to an embodiment of the invention. FIG. 2 is a schematic diagram illustrating the touch panel depicted in FIG. 1. Referring to FIG. 1 and FIG. 2, the electronic device 100 includes an electronic circuit 110 and a touch panel 120. The electronic circuit 110 is configurable to be coupled to the touch panel 120. The electronic circuit 110 is at least adapted to drive the touch panel 120 to perform a touch sensing operation in a touch sensing phase.

To be specific, the electronic circuit 110 includes a touch sensing circuit 112. The touch panel 120 includes a plurality of first signal lines TX1 to TXn, a plurality of second signal lines RX1 to RXm, and a plurality of touch sensors 122. The number of the first signal lines TX1 to TXn may be equal to or different from the number of the second signal lines RX1 to RXm. The touch sensing circuit 112 is configured to drive and control the touch sensors 122 to sense a touch event of the touch panel 120 via the first signal lines TX1 to TXn and the second signal lines RX1 to RXm.

In an embodiment, the touch sensing circuit 112 may include a touch controller, an analog front end (AFE) circuit, an analog-to-digital converter (ADC) circuit and other functional circuits for the touch sensing operation. The touch controller is configured to drive the touch panel 120 to perform the touch sensing operation in the touch sensing phase. The timing controller may be a processor having computational capability. Alternatively, the timing controller may be designed through hardware description languages (HDL) or any other design methods for digital circuits familiar to people skilled in the art and may be hardware circuits implemented through a field programmable gate array (FPGA), a complex programmable logic device (CPLD), or an application-specific integrated circuit (ASIC). In addition, enough teaching, suggestion, and implementation illustration for hardware structures of the touch sensing circuit 112 can be obtained with reference to common knowledge in the related art, which is not repeated hereinafter.

In the present embodiment, the electronic device 100 may be an electronic device having a display function, a touch sensing function and a fingerprint sensing function. In an embodiment, the electronic device 100 may be, but not limited to, a smartphone, a non-smart phone, a wearable electronic device, a tablet computer, a personal digital assistant, a notebook and other portable electronic devices that can operate independently and have the display function, the touch sensing function and the fingerprint sensing function. In an embodiment, the electronic device 100 may be, but not limited to, a portable or un-portable electronic device in a vehicle intelligent system. In an embodiment, the electronic device 100 may be, but not limited to, intelligent home appliances such as, a television, a computer, a refrigerator, a washing machine, a telephone, an induction cooker, a table lamp and so on.

In the present embodiment, the touch sensing phase includes a first sensing period and a second sensing period. The touch sensing circuit 112 receives the first sensing signal S1 including a first touch sensing data from the touch panel 120 in the first sensing period. The touch sensing circuit 112 receives the second sensing signal S2 including a second touch sensing data from the touch panel 120 in the first sensing period. The touch sensing circuit 112 compares the first sensing data to the second sensing data to determine a touch position of the touch event. The touch event may be an event of a finger touch, a stylus touch or a hover touch. By comparing the first sensing data to the second sensing data, the touch sensing circuit 112 can distinguish the touch event from noise interference. The noise interference may be from a charger or from large areas of water or other liquid. Therefore, the touch sensing circuit 112 can determine the position of the touch event on the touch panel according to the comparison result of the first touch sensing data and the second touch sensing data.

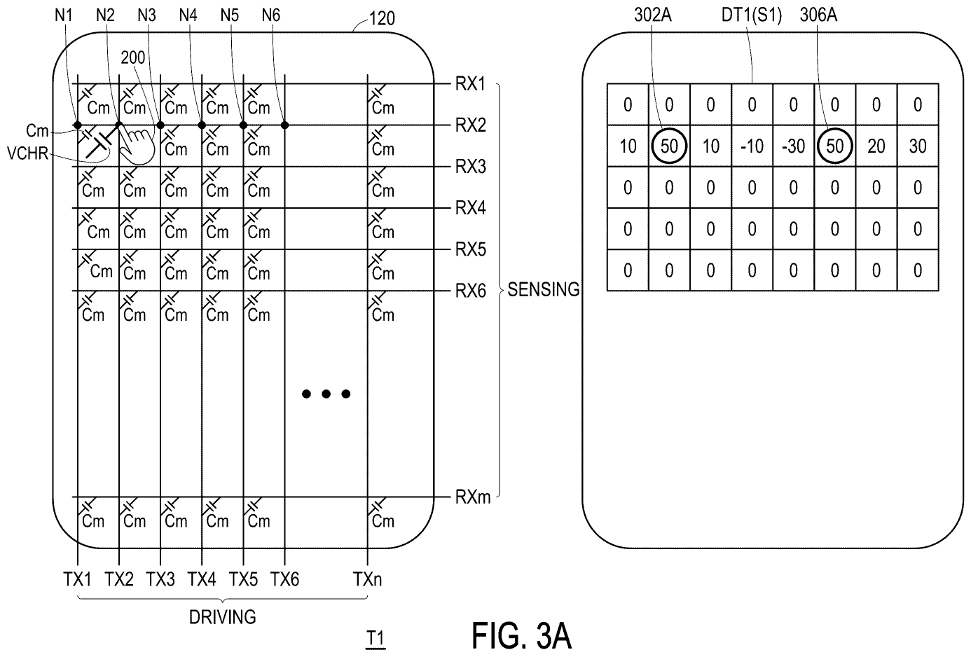

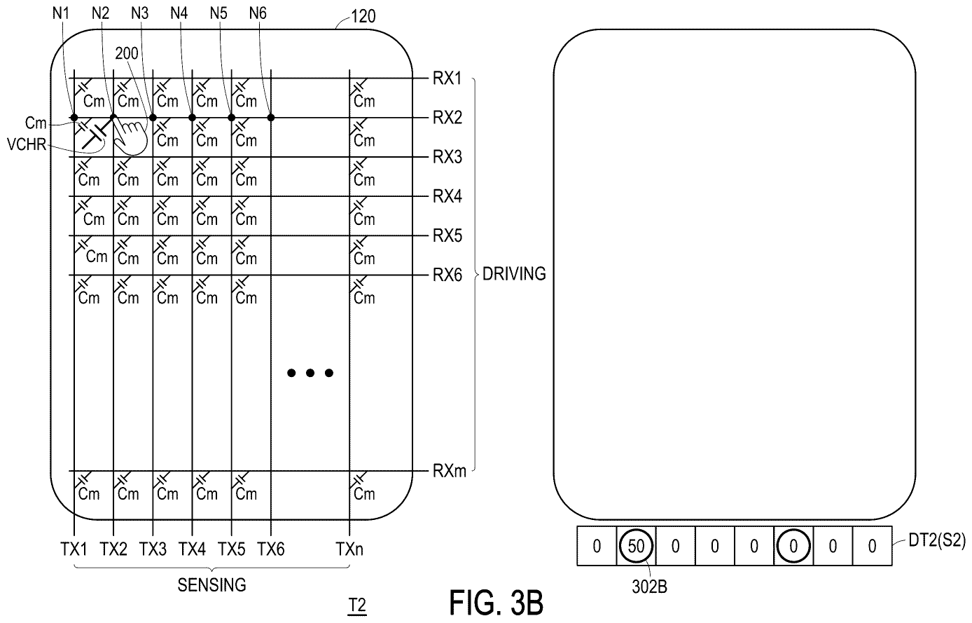

To be specific, FIG. 3A is a schematic diagram illustrating a first touch sensing data DT1 obtained in a first sensing period T1 according to an embodiment of the invention, and FIG. 3B is a schematic diagram illustrating a second touch sensing data DT2 obtained in a second sensing period T2 according to the embodiment of the invention. The first sensing period T1 can be conducted before or after the second sensing period T2.

In FIG. 3A, the first signal lines TX1 to TXn serve as driving lines, and the second signal lines RX1 to RXm serve as sensing lines in the first sensing period T1. The touch sensing circuit 112 outputs a driving signal Sd to the first signal lines TX1 to TXn, and receives the first sensing signal S1 from the second signal lines RX1 to RXm. The driving signal Sd may be sine waves, square waves, or triangular waves. The first sensing signal S1 includes the first touch sensing data DT1.

In the present embodiment, the touch event 200 occurs on a node N2 of the second signal line RX2. However, since the nodes on the second signal line RX2 are affected by a noise signal VCHR from a charger (not shown), the nodes N2 and N6 have larger sensing values 302A and 306A, e.g. 50, wherein the sensing values may be capacitance variations.

In FIG. 3B, the first signal lines TX1 to TXn serve as sensing lines, and the second signal lines RX1 to RXm serve as driving lines in the second sensing period T2. The touch sensing circuit 112 outputs the driving signal Sd to the second signal lines RX1 to RXm, and receives the second sensing signal S2 from the first signal lines TX1 to TXn. The second sensing signal S2 includes the second touch sensing data DT2.

In the second sensing period T2, the common mode interference of the noise signal VCHR and the driving signal Sd are not seen on the first signal line TX2. In this case, the first signal lines TX1 to TXn are configured to sense touch charges to distinguish the noise interference VCHR. Therefore, the second touch sensing data DT2 can correctly include the sensing value 302B. The positive sensing value 302B is a characteristic sensing value and indicates that the touch event 200 occurs on the node N2 of the second signal line RX2. The characteristic sensing value is configured for a reference of a determination of the touch event 200. In this case, the characteristic sensing value indicates the position of the touch event on the touch panel 200. The touch sensing circuit 11 can distinguish the touch event 200 from the noise interference, e.g. the noise signal VCHR, by comparing the first touch sensing data DT1 to the second touch sensing data DT2. The touch sensing circuit 112 can correctly determine that the touch event 200 occurs on the node N2 of the second signal line RX2.

In another embodiment, the driving signal Sd may be direct-current (DC) signals. In this case, the first signal lines TX1 to TXn are configured to sense interference charges to distinguish the noise interference VCHR. The noise signal VCHR is not seen on the first signal line TX2. Therefore, the touch sensing circuit 112 can still distinguish the touch event 200 from the noise interference VCHR by comparing the first touch sensing data DT1 to the second touch sensing data DT2.

In another embodiment, the touch sensing circuit 112 can drive the first signal lines TX1 to TXn in the manner of self-capacitive sensing to sense self-capacitive charges to distinguish the noise interference VCHR. That is to say, the first signal lines TX1 to TXn serve as driving lines and sensing lines in the second sensing period T2. The touch sensing circuit 112 applies the driving signals to the first signal lines TX1 to TXn, and receives the sensing signals via the first signal lines TX1 to TXn. In this case, the touch sensing circuit 112 can still distinguish the touch event 200 from the noise interference VCHR by comparing the first touch sensing data DT1 to the second touch sensing data DT2.

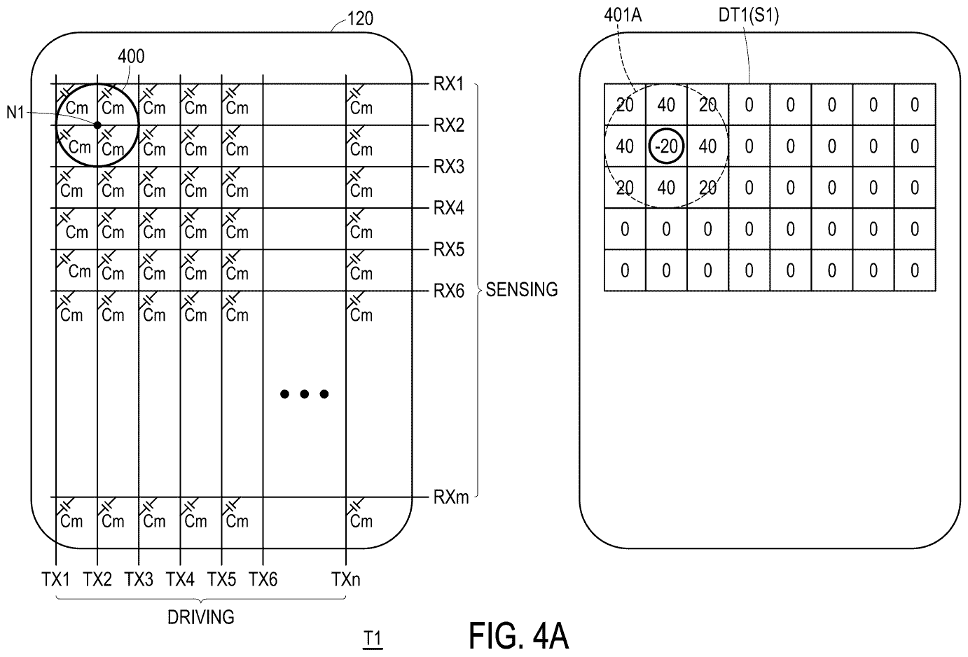

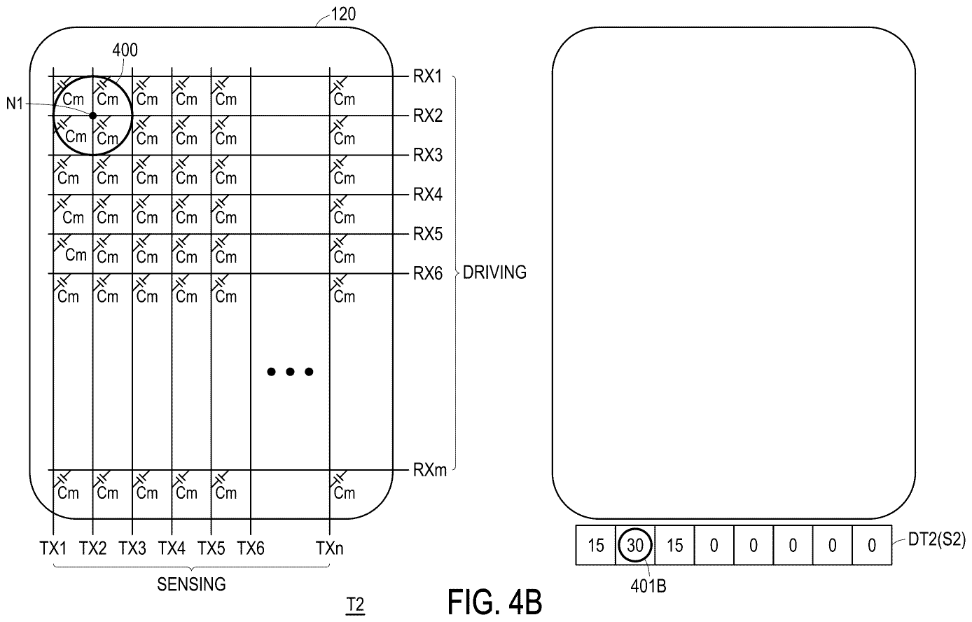

FIG. 4A is a schematic diagram illustrating a first touch sensing data DT1 obtained in a first sensing period T1 according to another embodiment of the invention, and FIG. 4B is a schematic diagram illustrating a second touch sensing data DT2 obtained in a second sensing period T2 according to another embodiment of the invention. In this embodiment, the first signal lines TX1 to TXn are configured to sense charges to determine whether a hover touch 400 occurs. The location of the hover touch 400 is centered on the node N1.

To be specific, in the first sensing period T1, the first signal lines TX1 to TXn serve as driving lines, and the second signal lines RX1 to RXm serve as sensing lines. The sensing values 401A show the electric field change of the hover touch 400 will make the mutual capacitance value of the center area become negative, and the mutual capacitance values of the edge area become positive. In this case, the mutual capacitance change of the center point will be mistaken as no touch, so that the touch sensing circuit 112 may mistakenly determine that there is no touch if simply considering the first touch sensing data DT1.

In the second sensing period T2, the first signal lines TX1 to TXn serve as sensing lines, and the second signal lines RX1 to RXm serve as driving lines. The first signal lines TX1 to TXn are configured to sense charges to determine whether the hover touch 400 occurs. The sensing value 401B corresponding to the center area of the hover touch 400 is a positive value. The positive sensing value 401B is a characteristic sensing value and indicates that the sensing target is the hover touch 400 and occurs on the node N1 of the second signal line RX2. Therefore, the touch sensing circuit 112 can determine the position of the hover touch 400 by comparing the first touch sensing data DT1 to the second touch sensing data DT2.

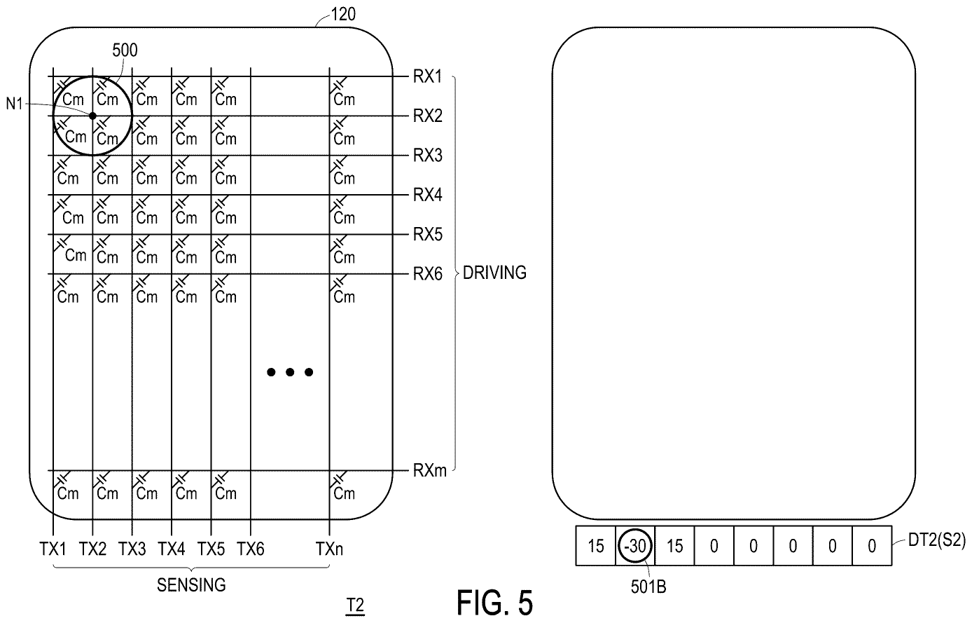

FIG. 5 is a schematic diagram illustrating a second touch sensing data DT2 obtained in a second sensing period T2 according to another embodiment of the invention. In this embodiment, the first signal lines TX1 to TXn are configured to sense charges to distinguish large areas 500 of water.

To be specific, in the first sensing period T1, the sensing values of the large areas 500 of water are similar to the sensing values 401A, but the sensing value 501B obtained in the second sensing period T2 is different. The electric field change of the large areas 500 of water will also make the mutual capacitance value of the center area become negative, and the mutual capacitance values of the edge area become positive. The sensing value 501B corresponding to the center area of the large areas 500 of water is a negative value. The negative sensing value 501B is a characteristic sensing value and indicates that the sensing target is water and located on the large areas 500 around the node N1 of the second signal line RX2. Therefore, the touch sensing circuit 112 can distinguish the large areas 500 of water from the hover touch 400 by comparing the first touch sensing data DT1 to the second touch sensing data DT2.

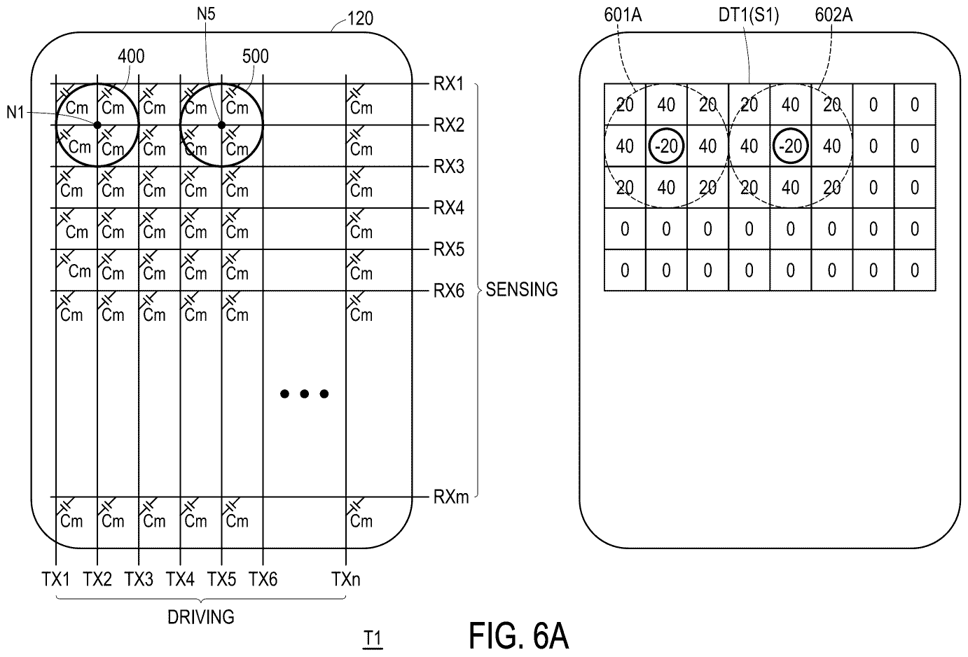

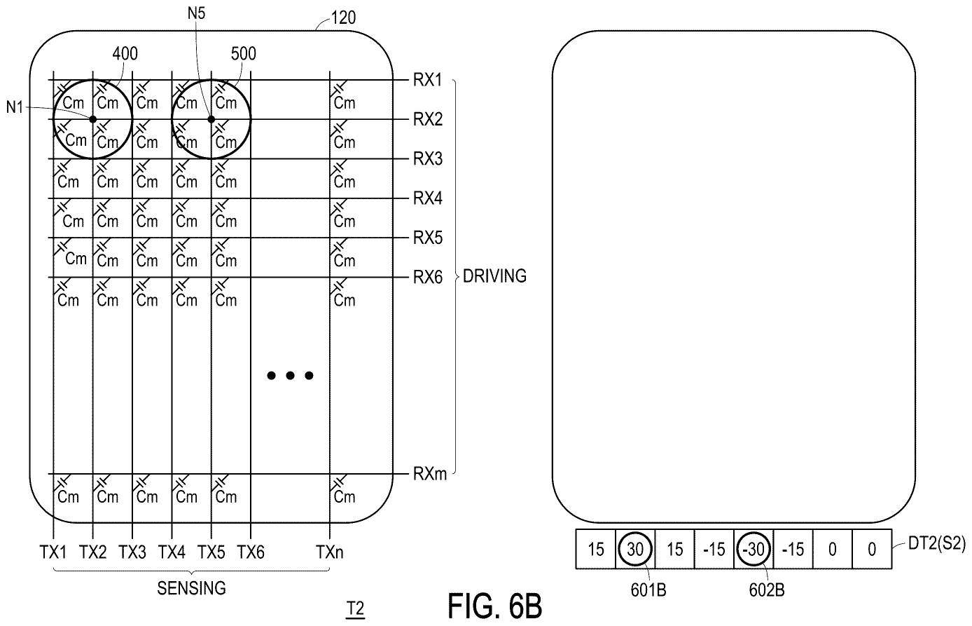

FIG. 6A is a schematic diagram illustrating a first touch sensing data DT1 obtained in a first sensing period T1 according to another embodiment of the invention, and FIG. 6B is a schematic diagram illustrating a second touch sensing data DT2 obtained in a second sensing period T2 according to another embodiment of the invention. In this embodiment, the first signal lines TX1 to TXn are configured to sense charges to distinguish the hover touch 400 from the large areas 500 of water. The locations of the hover touch 400 and the large areas 500 of water are centered on the nodes N1 and N5, respectively.

In the first sensing period T1, the sensing values 601A and 602A are obtained. In this case, if simply considering the first touch sensing data DT1, the touch sensing circuit 112 can not distinguish the hover touch 400 from the large areas 500 of water.

In the second sensing period T2, the positive sensing value 601B indicates that t hover touch 400 occurs on the node N1 of the second signal line RX2, and the negative sensing value 602B indicates that the water is located on the large areas around the node N1 of the second signal line RX2. Therefore, the touch sensing circuit 112 can distinguish the hover touch 400 from the large areas 500 of water by comparing the first touch sensing data DT1 to the second touch sensing data DT2.

In the embodiments of FIG. 3A to 6B, the first signal lines TX1 to TXn are configured to sense charges in the second sensing period T2, but the invention is not limited thereto. In another embodiment, the second signal lines RX1 to RXm can be configured to sense charges in the second sensing period T2. For example, in FIG. 3B, the first signal lines TX1 to TXn may serve as driving lines and the second signal lines may serve as sensing lines in the second sensing period T2. For another example, in the case of self-capacitive sensing, the second signal lines RX1 to RXm may serve as driving lines and sensing lines in the second sensing period T2.

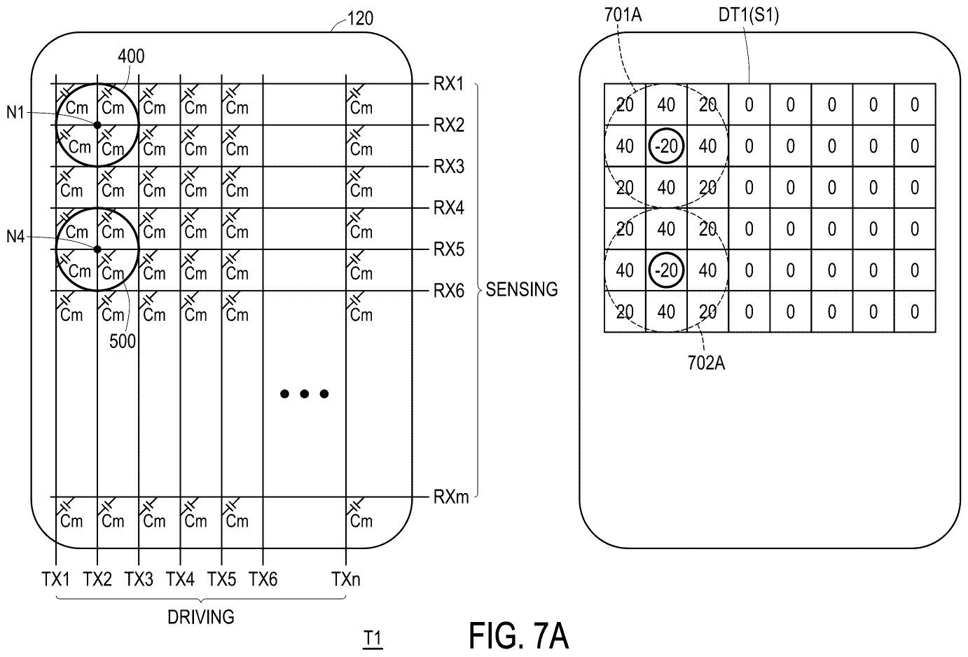

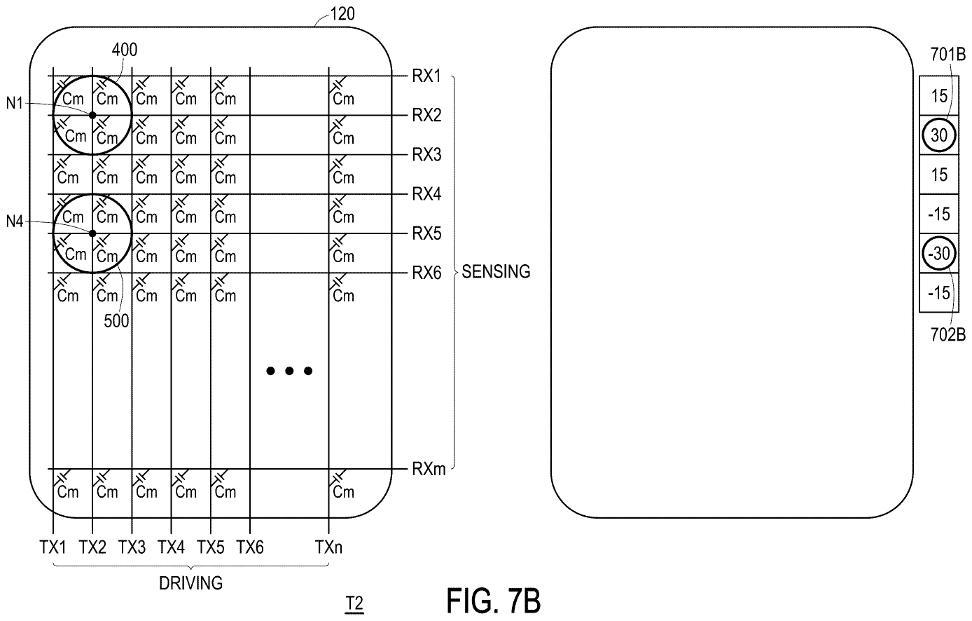

Taking the hover touch 400 and the large areas 500 of water for another example, FIG. 7A is a schematic diagram illustrating a first touch sensing data DT1 obtained in a first sensing period T1 according to another embodiment of the invention, and FIG. 7B is a schematic diagram illustrating a second touch sensing data DT2 obtained in a second sensing period T2 according to another embodiment of the invention. In this embodiment, the second signal lines RX1 to RXm are configured to sense charges in the second sensing period T2 to distinguish the hover touch 400 from the large areas 500 of water. The locations of the hover touch 400 and the large areas 500 of water are centered on the nodes N1 and N4, respectively.

In the first sensing period T1, the sensing values 701A and 702A are obtained. In this case, if simply considering the first touch sensing data DT1, the touch sensing circuit 112 can not distinguish the hover touch 400 from the large areas 500 of water.

In the second sensing period T2, the first signal lines TX1 to TXn serve as driving lines, and the second signal lines RX1 to RXm serve as sensing lines. The positive sensing value 701B indicates that the hover touch 400 occurs on the node N1 of the second signal line RX2, and the negative sensing value 702B indicates that the water is located on the large areas around the node N1 of the second signal line RX2. Therefore, the touch sensing circuit 112 can distinguish the hover touch 400 from the large areas 500 of water by comparing the first touch sensing data DT1 to the second touch sensing data DT2.

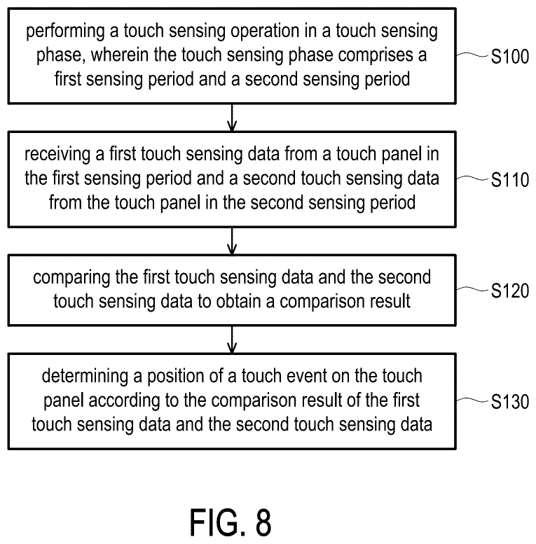

FIG. 8 is a flowchart illustrating steps in a touch sensing method according to an embodiment of the invention. Referring to FIG. 1, FIG. 2 and FIG. 8, in the present embodiment, the touch sensing method is at least adapted to the electronic device 100 depicted in FIG. 1, but the invention is not limited thereto. Taking the electronic device 100 for example, in step S100, the touch sensing circuit 112 performs a touch sensing operation in a touch sensing phase. The touch sensing phase includes a first sensing period T1 and a second sensing period T2. In step S110, the touch sensing circuit 112 receives a first touch sensing data DT1 from the touch panel 120 in the first sensing period T1 and a second touch sensing data DT2 from the touch panel 120 in the second sensing period T2. In step S120, the touch sensing circuit 112 compares the first touch sensing data DT1 and the second touch sensing data DT2 to obtain a comparison result. In step S130, the touch sensing circuit 112 determines a position of a touch event on the touch panel 120 according to the comparison result of the first touch sensing data DT1 and the second touch sensing data DT2.

The touch sensing method described in the embodiment of the invention is sufficiently taught, suggested, and embodied in the embodiments illustrated in FIG. 1 to FIG. 7B, and therefore no further description is provided herein.

In summary, in the embodiments of the invention, in the event of a water droplet affecting the touch panel, the touch sensing circuit is able to recognize the water and ignore the droplet, responding to the finger touch. In the event of hover touch, the touch sensing circuit may automatically filter or adjust the sensitivity to avoid misrecognition as a touch.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. An electronic device, comprising:
a touch panel, comprising a plurality of first signal lines and a plurality of second signal lines, and configured to perform a touch sensing operation in a touch sensing phase, wherein the touch sensing phase comprises a first sensing period and a second sensing period; and
a touch sensing circuit, coupled to the touch panel, and configured to drive the touch panel to perform the touch sensing operation in the touch sensing phase,
wherein the touch sensing circuit receives a first touch sensing data from the touch panel in the first sensing period and a second touch sensing data from the touch panel in the second sensing period, and determines a position of a touch event on the touch panel according to a comparison result of the first touch sensing data and the second touch sensing data.

2. The electronic device according to claim 1, wherein the plurality of first signal lines serve as driving lines in the first sensing period, and the plurality of second signal lines serve as sensing lines in the first sensing period.

3. The electronic device according to claim 2, wherein the plurality of first signal lines serve as sensing lines in the second sensing period, and the plurality of second signal lines serve as driving lines in the second sensing period.

4. The electronic device according to claim 2, wherein the plurality of first signal lines serve as driving lines in the second sensing period, and the plurality of second signal lines serve as sensing lines in the second sensing period.

5. The electronic device according to claim 2, wherein the plurality of first signal lines serve as driving lines and sensing lines in the second sensing period.

6. The electronic device according to claim 2, wherein the plurality of second signal lines serve as driving lines and sensing lines in the second sensing period.

7. The electronic device according to claim 1, wherein the touch sensing circuit compares the first touch sensing data and the second touch sensing data to obtain the comparison result.

8. The electronic device according to claim 1, wherein the second touch sensing data comprises a characteristic sensing value, and the characteristic sensing value is configured for a reference of a determination of the touch event.

9. The electronic device according to claim 8, wherein the characteristic sensing value indicates the position of the touch event on the touch panel.

10. The electronic device according to claim 8, wherein the characteristic sensing value indicates that a sensing target is the touch event or a noise interference.

11. A touch sensing circuit, comprising:
a touch controller, coupled to a touch panel, and configured to drive the touch panel to perform a touch sensing operation in a touch sensing phase, wherein the touch sensing phase comprises a first sensing period and a second sensing period,
wherein the touch controller receives a first touch sensing data from the touch panel in the first sensing period and a second touch sensing data from the touch panel in the second sensing period, and determines a position of a touch event on the touch panel according to a comparison result of the first touch sensing data and the second touch sensing data.

12. The touch sensing circuit according to claim 11, wherein the touch controller compares the first touch sensing data and the second touch sensing data to obtain the comparison result.

13. The touch sensing circuit according to claim 11, wherein the second touch sensing data comprises a characteristic sensing value, and the characteristic sensing value is configured for a reference of a determination of the touch event.

14. The touch sensing circuit according to claim 13, wherein the characteristic sensing value indicates the position of the touch event on the touch panel.

15. The touch sensing circuit according to claim 13, wherein the characteristic sensing value indicates that a sensing target is the touch event or a noise interference.

16. A touch sensing method, comprising:
performing a touch sensing operation in a touch sensing phase, wherein the touch sensing phase comprises a first sensing period and a second sensing period;
receiving a first touch sensing data from a touch panel in the first sensing period and a second touch sensing data from the touch panel in the second sensing period;
comparing the first touch sensing data and the second touch sensing data to obtain a comparison result; and
determining a position of a touch event on the touch panel according to the comparison result of the first touch sensing data and the second touch sensing data.

17. The touch sensing method according to claim 16, wherein the second touch sensing data comprises a characteristic sensing value, and the characteristic sensing value is configured for a reference of a determination of the touch event.

18. The touch sensing method according to claim 17, wherein the characteristic sensing value indicates the position of the touch event on the touch panel.

19. The touch sensing method according to claim 17, wherein the characteristic sensing value indicates that a sensing target is the touch event or a noise interference.
